(19) United States
(12) Patent Application Publication
(10) Pub. No.: US 2025/0176570 A1
(43) Pub. Date: Jun. 5, 2025

(54) Multi-Stack Micro-Gap Discharge Type Atomization Automatic Humidifier

(71) Applicant: Innovation Center of Yangtze River Delta, ZJU, Jiaxing (CN)

(72) Inventors: Xinyu LIAO, Jiaxing (CN); Tian DING, Jiaxing (CN); Hu SHI, Jiaxing (CN); Xingyu CHEN, Jiaxing (CN)

(73) Assignee: Innovation Center of Yangtze River Delta, ZJU, Jiaxing (CN)

(21) Appl. No.: 18/438,297

(22) Filed: Feb. 9, 2024

(30) Foreign Application Priority Data
Dec. 5, 2023 (CN) 2023116599106

(51) Int. Cl. A23L 3/00; A23B 7/015; A23L 3/26; B05B 17/04

(52) U.S. Cl. CPC A23B 2/001; A23B 2/003; A23B 2/50; A23B 7/015; B05B 17/04

(57) ABSTRACT

Disclosed is a multi-stack micro-gap discharge type atomization automatic humidifier, relating to the technical field of cold chain logistics equipment for food. The automatic humidifier includes a water tank, one side of the top of the water tank is provided with a mist outlet tube, a power supply module and an atomization device are arranged at the bottom of the water tank, and the power supply module is electrically connected to the atomization device. A multi-stack micro-gap discharge generator is arranged in the mist outlet tube. The multi-stack micro-gap discharge generator can shorten the discharge gap, thus guaranteeing the uniformity of discharge wires and effectively ensuring the space utilization rate. A cold-conducting block in a refrigeration device is embedded into an inner wall surface of a mist outlet round tube, which is used to cool water mist in a mist outlet tube.

### CROSS-REFERENCE TO RELATED APPLICATION

This patent application claims the benefit and priority of Chinese Patent Application No. 2023116599106 filed with the China National Intellectual Property Administration on Dec. 5, 2023, the disclosure of which is incorporated by reference herein in its entirety as part of the present application.

### TECHNICAL FIELD

The present disclosure relates to the technical field of cold chain logistics equipment for food, and in particular to a multi-stack micro-gap discharge type atomization automatic humidifier.

### BACKGROUND

The cold chain transportation rate in China is still far lower than that in developed countries, and the cold chain decay rate is also high. Moisture retention and disinfection during cold chain transportation seriously affect the freshness of fresh food.

In a patent with Publication No. CN116379552A, an air humidifying, purifying and disinfecting machine is disclosed. The air humidifying, purifying and disinfecting machine includes a housing, which is internally provided with an inner cavity, and an air inlet and an air outlet communicating with the inner cavity; a fan, which is arranged in the inner cavity and used for making the air flow from the air inlet to the air outlet; a steam generator, which is arranged in the housing, and is provided with a steam channel communicating with the inner cavity; a heater assembly, including a first heater arranged in the steam generator and at least one second heater arranged in the steam channel, where the heating temperature of the second heater is higher than that of the first heater; and a purification device, which is arranged in the inner cavity. The technical solution of the invention aims at designing an air humidifying, purifying and disinfecting machine which can sterilize air and reduce ozone emission.

The air humidifying, purifying and disinfecting machine above is used to humidify and disinfect the air, which is difficult to satisfy the requirements of cold chain transportation.

### SUMMARY

In order to solve the above technical problem, a multi-stack micro-gap discharge type atomization automatic humidifier is provided, which can improve the activation rate of a water mist beam, inhibit the growth of microorganisms, slow down spoilage, and effectively prolong the cycle of cold chain logistics, thus expanding the sales radius of fresh food.

To achieve the objective above, some embodiments employ the following technical solution:

A multi-stack micro-gap discharge type atomization automatic humidifier includes a water tank. One side of the top of the water tank is provided with a mist outlet tube, a power supply module and an atomization device are arranged at the bottom of the water tank, and the power supply module is electrically connected to the atomization device. A multi-stack micro-gap discharge generator is arranged in the mist outlet tube. The multi-stack micro-gap discharge generator includes metal electrode sheets, insulating square tubes and barrier media. The metal electrode sheets and the barrier media are alternately stacked, the insulating square tubes are arranged on both sides of the barrier media, and the metal electrode sheets and the barrier media are electrically connected to a positive electrode and a negative electrode of the power supply module, respectively.

Alternatively, the barrier media are quartz glass sheets.

Alternatively, the insulating square tubes are insulating silicone square tubes.

Alternatively, a refrigeration device is arranged at one side of the mist outlet tube, a main motor is arranged at the bottom of the water tank, the main motor is electrically connected to the power supply module, and the main motor is configured to drive the refrigeration device.

Alternatively, the top of the water tank is provided with a top water injection port.

Alternatively, a lower part of the water tank is provided with an external water injection port.

Alternatively, a front side of the water tank is provided with a control screen, and the control screen is electrically connected to the power supply module and the atomization device.

Alternatively, one side of the water tank is provided with a driving element, the driving element includes a driving motor, a controller, and a driving circuit. The driving circuit is electrically connected to the controller and the driving motor, and the controller is electrically connected to the control screen.

Alternatively, the water tank is provided with a self-cleaning inlet port.

Compared with the prior art, some embodiments obtain the following beneficial technical effects.

The barrier media and the metal electrode sheets are stacked in multiple layers, and are fixed by an acrylic box which has holes with a fixed spacing, such that when the discharge area is multiplied, the discharge gap can be shortened, the uniformity of discharge wires can be guaranteed, and the space utilization rate can be effectively guaranteed.

The refrigeration device is located below the multi-stack micro-gap discharge generator, the cold-conducting block is embedded into an inner wall surface of a mist outlet round tube, which is used to cool the water mist in a mist outlet tube and improve the solubility of active oxygen, active nitrogen and other particles in the water mist. Moreover, by optimizing the length of a short side of a dielectric plate in the multi-stack micro-gap discharge generator to be in consistent with a diameter of the mist outlet tube, the proportion of an atomized water beam passing through the multi-stack micro-gap discharge generator can be significantly increased, thus improving the activation rate of a water mist beam.

### BRIEF DESCRIPTION OF THE DRAWINGS

In order to illustrate the embodiments of the present disclosure or the technical solutions in the prior art more clearly, the drawings needed in the embodiments will be briefly introduced hereinafter. Apparently, the drawings in the following description are only some embodiments of the present disclosure. For those skilled in the art, other drawings can be obtained according to these drawings without paying creative labor.

FIG. 1 is a structural schematic diagram of a multi-stack micro-gap discharge type atomization automatic humidifier according to the present disclosure;

FIG. 2 is a schematic diagram of an internal structure of a multi-stack micro-gap discharge type atomization automatic humidifier according to the present disclosure;

FIG. 3 is a schematic diagram of a layout structure of a driving element in a multi-stack micro-gap discharge type atomization automatic humidifier according to the present disclosure;

FIG. 4 is a structural schematic diagram of a mist outlet tube of a multi-stack micro-gap discharge type atomization automatic humidifier according to the present disclosure;

FIG. 5 is a structural schematic diagram of a multi-stack micro-gap discharge generator in a multi-stack micro-gap discharge type atomization automatic humidifier according to the present disclosure;

FIG. 6 is a structural schematic diagram of a refrigeration device in a multi-stack micro-gap discharge type atomization automatic humidifier according to the present disclosure;

FIG. 7 is a structural schematic diagram of a self-cleaning mist outlet round tube in a multi-stack micro-gap discharge type atomization automatic humidifier according to the present disclosure;

FIG. 8 is a diagram illustrating use effect of storing red globe grapes by a multi-stack micro-gap discharge type atomization automatic humidifier according to the present disclosure;

FIG. 9 is a diagram illustrating use effect of storing red globe grapes by a refrigerator according to the present disclosure.

FIG. 10 is a diagram illustrating use effect of storing strawberries by a multi-stack micro-gap discharge type atomization automatic humidifier according to the present disclosure; and

FIG. 11 is a diagram illustrating use effect of storing strawberries by a refrigerator according to the present disclosure.

In the drawings: 1 water tank; 2 mist outlet tube orifice; 3 top water injection port; 4 external water injection port; 5 power supply module; 6 atomization device; 7 water outlet; 8 self-cleaning inlet port; 9 control screen; 10 driving element; 11 main motor; 12 refrigeration device; 13 mist outlet tube; 14 multi-stack micro-gap discharge generator; 15 temperature sensor; 16 metal electrode sheet; 17 insulating silicone square tube; 18 barrier medium; 19 heat insulation cotton; 20 refrigeration sheet; 21 cold-conducting block; 22 heat dissipation block; 23 cold-end small fan; 24 hot-end fan; 25 waterproof fan; 26 waterproof small fan; 27 self-cleaning mist outlet round tube.

### DETAILED DESCRIPTION OF THE EMBODIMENTS

The technical solutions in the embodiments of the present disclosure will be described clearly and completely hereinafter with reference to the drawings of the embodiments of the present disclosure. Apparently, the described embodiments are some embodiments of the present disclosure, rather than all of the embodiments. Based on the embodiments of the present disclosure, all other embodiments obtained by those skilled in the art without paying creative labor fall in the scope of protection of the present disclosure.

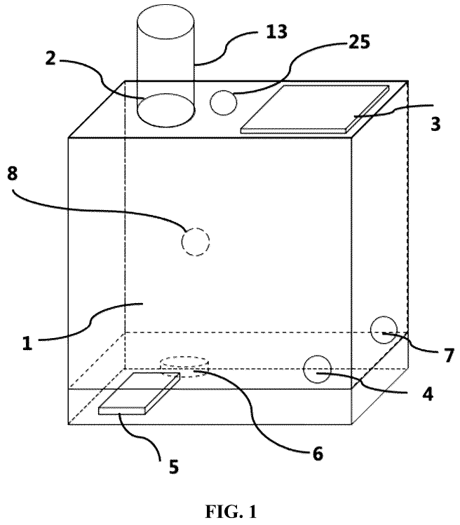

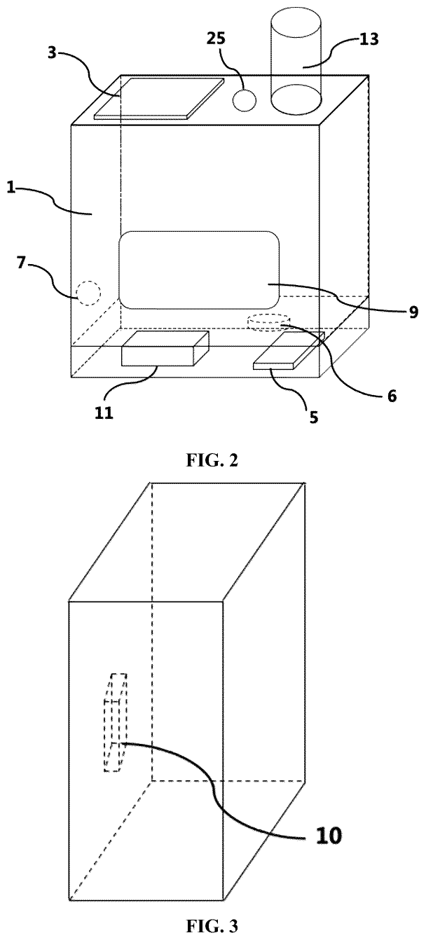

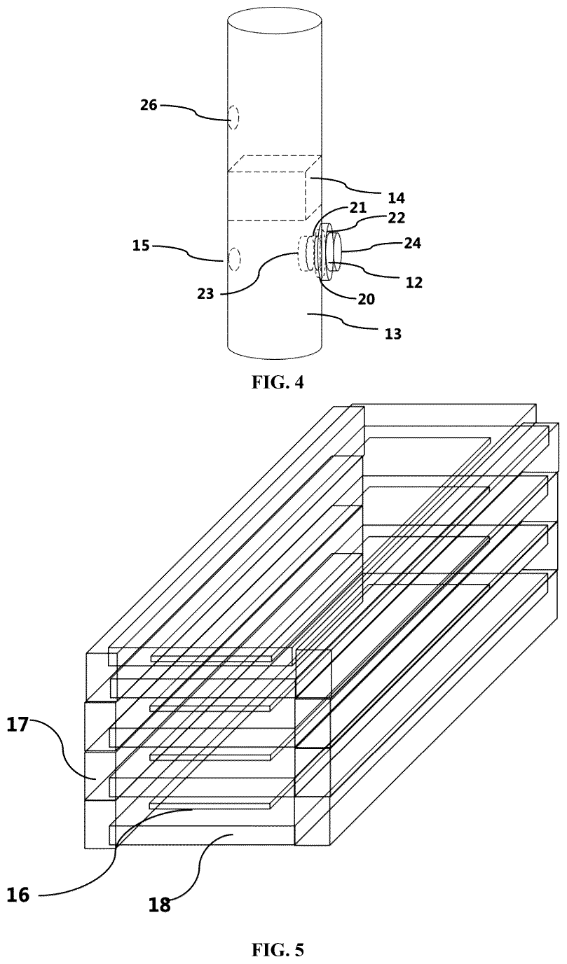

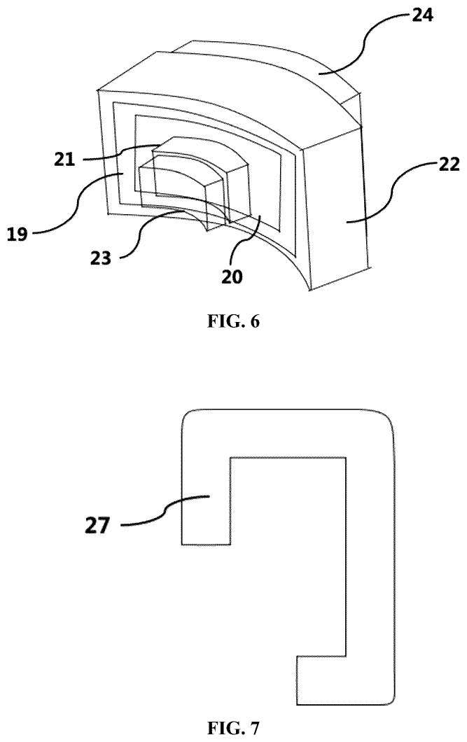

As shown in FIG. 1 to FIG. 7, a multi-stack micro-gap discharge type atomization automatic humidifier is provided according to this embodiment, including a water tank 1. One side of the top of the water tank 1 is provided with a mist outlet tube orifice 2, and the mist outlet tube orifice 2 communicates with a mist outlet tube 13. A power supply module 5 and an atomization device 6 are arranged at the bottom of the water tank 1, and the power supply module 5 is electrically connected to the atomization device 6. A multi-stack micro-gap discharge generator 14 is arranged in the mist outlet tube 13. The multi-stack micro-gap discharge generator 14 includes metal electrode sheets 15, insulating silicone square tubes 16 and barrier media 17. The metal electrode sheets 15 and the barrier media 17 are alternately stacked, the insulating square tubes 16 are arranged on both sides of the barrier media 17, and the metal electrode sheets 15 and the barrier media 17 are electrically connected to a positive electrode and a negative electrode of the power supply module 5, respectively.

In this specific embodiment, the barrier medium 17 is a quartz glass sheet. The insulating square tube is an insulating silicone square tube 16. One metal electrode sheet 15 having the same shape is placed between two barrier media 17, and then the insulating silicone square tubes hermetically wrap the long side surfaces of the barrier media 17 to form a structure, and such structures are stacked from bottom to top, and are fixed by an acrylic box. The metal electrode sheet extends 1-2 cm on the long side surface of the barrier medium 17 to form an electrode terminal interface. Input and output high-voltage wires, by means of fixers, are fixed on different side surfaces of the mist outlet tube 13 with a distance of more than 20 cm from each other. The insulating silicone square tube 16 has a wall thickness of 1 mm and is made of heat-resistant silicone. A spacing between the barrier media 17 is 1-2 mm. When the discharge area is doubled, the discharge gap can be shortened, the uniformity of discharge wires can be guaranteed, and the space utilization rate can be effectively guaranteed.

One side of the mist outlet tube 13 is provided with a refrigeration device 12, and the other side of the mist outlet tube 13 is provided with a temperature sensor 15. A main motor 11 is arranged at the bottom of the water tank 1, the main motor 11 is electrically connected to the power supply module 5, and the main motor 11 is used to drive the refrigeration device 12.

The top of the water tank 1 is provided with a top water injection port 3.

The top of the water tank 1 is provided with a waterproof fan 25, with an adjustable voltage range of 3-24 V. The fan twitches an atomized beam in the tank upwards and drives the atomized beam to pass through the mist outlet tube 13, so as to control the flow velocity of the atomized beam.

The lower part of the water tank 1 is provided with an external water injection port 4.

A front side of the water tank 1 is provided with a control screen 9, and the control screen 9 is electrically connected to the power supply module 5 and the atomization device 6.

One side of the water tank 1 is provided with a driving element 10. The driving element 10 includes a driving motor, a controller, and a driving circuit. The driving circuit is electrically connected to the controller and the driving motor, respectively, and the controller is electrically connected to the control screen 9.

The water tank 1 is provided with a self-cleaning inlet port 8.

The water tank 1 is provided with a water outlet 7.

The main motor 11, after being started, provides power for the whole system. The main motor is used for providing power for the refrigeration device 12 to ensure the operation of the refrigeration device 12. The refrigeration device 12 starts to operate, and the temperature in the mist outlet tube 13 is ensured to reach 20+/−1° C. as measured by the temperature sensor 15. When the temperature in the mist outlet tube 13 reaches the set temperature, a high-voltage and high-frequency power supply in the power supply module 5 is driven to operate, and the multi-stack micro-gap discharge generator 14 is started, at this time, the air in the mist outlet tube 13 passes through the multi-stack micro-gap discharge generator 14, and is coupled to a discharge gap through a dielectric capacitor under an input high voltage, thus forming a strong electric field. Charged particles such as electrons gain energy under the action of the electric field, and react with surrounding air molecules (e.g., oxygen molecules, nitrogen molecules, etc.) by inelastic collision and ionization, so as to transfer the energy of the electric field to gas molecules in the air. With the increasing level of excited gas molecules, electron avalanche is triggered, and space charges are formed to enhance a formed local electric field. The charges and electrons in the electric field form electric field waves, and as the charges move faster than the electrons, a conductive channel is formed, and a large number of fine pulse streamer discharges are formed in the spacing between the barrier media 17, thus forming rich active particles (OH, O, H₂O₂, O₃, ONOOH, etc.). Meanwhile, the atomization device 6 starts to operate, the high-frequency vibration of an atomizing sheet in the atomization device 6 is used to atomize the water surface into water mist with small particles, and strong electric energy will break the water into tiny floating particles, so as to form an atomized beam. The waterproof fan 25 drives the atomized beam to pass through the mist outlet tube, and the refrigerating device 12 is used for maintaining a specific temperature range, which includes heat insulation cotton 19, a refrigeration sheet 20, a cold-conducting block 21, a heat dissipation block 22, a cold-end small fan 23, and a hot-end fan 24. The surface of the cold-conducting block 21 is coated with heat-conducting silicone grease, which is attached to a refrigeration surface of the refrigeration sheet 20, the heat insulation cotton 19 is placed around the refrigeration sheet, and the cold-end small fan 23 is located on the surface of the cold-conducting block 21, and the heat dissipation block 22 is attached to a heat surface of the refrigeration sheet 20 through the heat-conductive silicone grease. The hot-end fan 24 is located on the surface of the heat dissipation block 22, and the cold-conducting block 21 is embedded into the inner surface of the mist outlet tube 13. The refrigeration device 12 is used to cool the atomized beam, and the water mist is conveyed to pass through the multi-stack micro-gap discharge generator 14 for primary activation. The smaller the water droplets are, the larger the contact surface with the plasma gas is, and the higher the solubility is. At this time, the atomized beam is a mixture of partially activated water mist and the plasma gas components, and the active particles are dissolved in the atomized beam to form an initially activated atomized beam.

Under the action of a waterproof small fan 26, the initially activated water mist is liquefied and compressed in a small range under the action of wind force. In the process that small water droplets condense into larger water droplets, the water and plasma gas components are further dissolved, which further improves the activation degree of the water mist. After secondary activation, the water mist particles are larger, which can cover samples in a longer distance under the action of wind force, making the effect better. Through the mist outlet tube 13, the atomized beam is sprayed to food or environment, thus achieving the function of sterilization and disinfection. A time control device can automatically control the operation-stop cycle of the humidifier according to the settings of an operator.

After operating for a period of time, if the water tank 1 needs to be cleaned, the operator can choose a self-cleaning mode in the control screen 9, a self-cleaning mist outlet round tube 27 is connected to a cleaning inlet 8, and water is added into the top water injection port 3 of a water storage tank 1 on the side surface of a box body until a scale line is reached, or a water pipe is connected by the external water injection port 4 for automatic water injection. After the main motor 11, after being started, provides power for the whole system. The main motor is used for providing power for the refrigeration device 12 to ensure the operation of the refrigeration device 12. The refrigeration device 12 starts to operate, and the temperature in the mist outlet tube 13 is ensured to reach 20+/−1° C. as measured by the temperature sensor 15. When the temperature in the mist outlet tube 13 reaches the set temperature, a high-voltage and high-frequency power supply is started to operate, and the multi-stack micro-gap discharge generator 14 is started. The air the air in the mist outlet tube 13 passes through the multi-stack micro-gap discharge generator 14 to form rich active particles. Meanwhile, the atomization device 6 starts to operate, the atomizing sheet oscillates, and the fan drives the atomized beam to pass through the mist outlet tube 13. The refrigeration device 12 cools the atomized beam, and then the atomized beam passes through the multi-stack micro-gap discharge generator 14 to generate an activated atomized beam. After passing through the self-cleaning mist outlet round tube, the activated mist is conveyed back to the water tank 1 and diffused in the water tank 1, so as to self-clean and disinfect the inner wall of the water tank 1 and the air environment. The residual water after cleaning is drained through the water outlet 7.

Due to short shelf life, the red globe grapes and strawberries are selected for cold chain logistics preservation experiment. Fresh red globe grapes and strawberries with uniform size and without mechanical damage are selected, and are transported to a laboratory immediately after harvesting. Rotten fruit, cracked fruit and mechanically damaged fruit are eliminated, and the red globe grapes and strawberries with intact fruit grains, uniform size, uniform color and similar maturity are selected as experimental materials. The fresh red globe grapes and strawberries are laid flat on super display cabinets, and are humidified with ordinary water mist to serve as the control group.

The setting mode as follows: running the multi-stack micro-gap discharge type atomization automatic humidifier for 10 min every 4 h, setting the temperature as 20+/−1° C., the input power as 80 W, a pH value of the water mist as 2.2, and an ORP (oxidation-reduction potential) value as 542 mV.

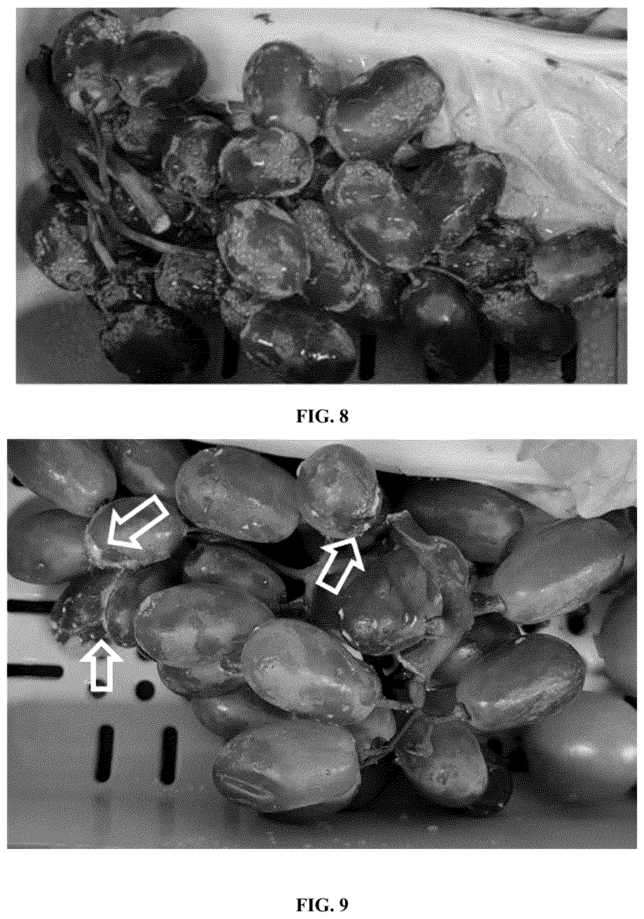

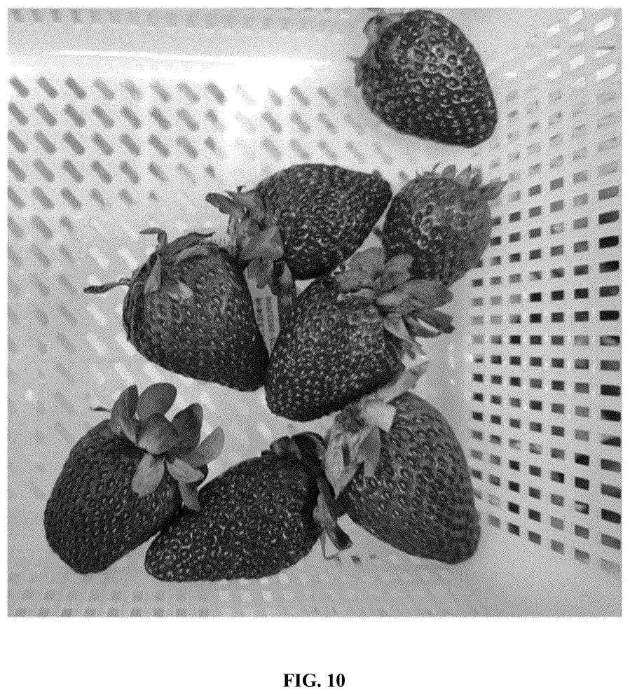

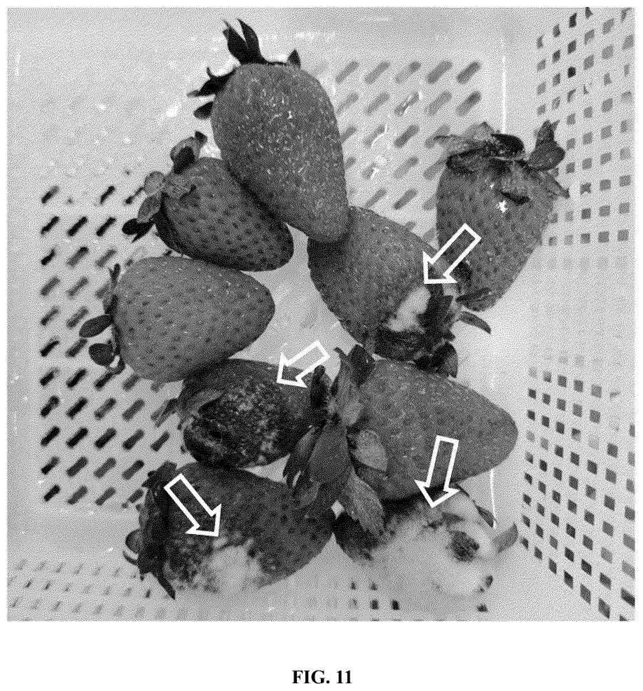

As shown in FIG. 8 to FIG. 11, FIG. 8 shows red globe grapes placed in the multi-stack micro-gap discharge type atomization automatic humidifier, and FIG. 9 shows red globe grapes placed at room temperature after ordinary water mist humidification. FIG. 10 shows strawberries placed in the multi-stack micro-gap discharge type atomization automatic humidifier, and FIG. 11 shows strawberries placed at room temperature after ordinary water mist humidification. It can be found that the red globe grapes or strawberries placed in the multi-stack micro-gap discharge type atomization automatic humidifier are still fresh and free of mold growth, while there is obvious mold growth on the red globe grapes or strawberries in the control group, especially nearly 50% of the strawberries in the control group (ordinary water mist humidification treatment) have mold growth.

It should be noted that it is apparent to those skilled in the art that the present disclosure is not limited to the details of the above exemplary embodiments, and can be realized in other specific forms without departing from the spirit or basic characteristics of the present disclosure. Therefore, the embodiments should be considered as exemplary and non-limiting in all aspects, and the scope of the present disclosure is defined by the appended claims rather than the above description, so it is intended to embrace all changes that fall within the meaning and range of equivalents of the claims, and any reference signs in the claims should not be regarded as limiting the claims involved.

In this specification, specific embodiments aim to illustrate the principle and implementation of the present disclosure. The explanation of the above embodiments is only used to help understand the method and its core idea of the present disclosure. According to the idea of the present disclosure, there will be some changes in the specific implementation and application scope for those skilled in the art. To sum up, the contents of this specification should not be construed as limiting the present disclosure.

What is claimed is:

1. A multi-stack micro-gap discharge type atomization automatic humidifier, comprising a water tank, wherein one side of a top of the water tank is provided with a mist outlet tube, a power supply module and an atomization device are arranged at a bottom of the water tank, and the power supply module is electrically connected to the atomization device; a multi-stack micro-gap discharge generator is arranged in the mist outlet tube; the multi-stack micro-gap discharge generator comprises metal electrode sheets, insulating square tubes and barrier media, wherein the metal electrode sheets and the barrier media are alternately stacked, the insulating square tubes are arranged on both sides of the barrier media.

2. The multi-stack micro-gap discharge type atomization automatic humidifier according to claim 1, wherein the barrier media are quartz glass sheets.

3. The multi-stack micro-gap discharge type atomization automatic humidifier according to claim 1, wherein the insulating square tubes are insulating silicone square tubes.

4. The multi-stack micro-gap discharge type atomization automatic humidifier according to claim 1, wherein a refrigeration device is arranged at one side of the mist outlet tube, a main motor is arranged at the bottom of the water tank, the main motor is electrically connected to the power supply module, and the main motor is configured to drive the refrigeration device.

5. The multi-stack micro-gap discharge type atomization automatic humidifier according to claim 1, wherein the top of the water tank is provided with a top water injection port.

6. The multi-stack micro-gap discharge type atomization automatic humidifier according to claim 1, wherein a lower part of the water tank is provided with an external water injection port.

7. The multi-stack micro-gap discharge type atomization automatic humidifier according to claim 1, wherein a front side of the water tank is provided with a control screen, and the control screen is electrically connected to the power supply module and the atomization device.

8. The multi-stack micro-gap discharge type atomization automatic humidifier according to claim 7, wherein one side of the water tank is provided with a driving element, the driving element comprises a driving motor, a controller, and a driving circuit; the driving circuit is electrically connected to the controller and the driving motor, and the controller is electrically connected to the control screen.

9. The multi-stack micro-gap discharge type atomization automatic humidifier according to claim 1, wherein the water tank is provided with a self-cleaning inlet port.
